(19) United States
(12) Patent Application Publication
(10) Pub. No.: US 2003/0189497 A1
(43) Pub. Date: Oct. 9, 2003

(54) Radio frequency siren system

(76) Inventor: Yong Min Cho, Silver Spring, MD (US)

Correspondence Address: Mr. Yong Min Cho, 16605 Sea Island Court, Silver Spring, MD, 20905, US

(21) Appl. No.: 10/116,003

(22) Filed: Apr. 5, 2002

(51) Int. Cl. G08G 1/00

(52) U.S. Cl. 340/902; 340/425.5

(57) ABSTRACT

As cars become more soundproof, it also becomes more difficult to hear the sirens of emergency vehicles. It is even difficult to hear the sirens of emergency vehicles in the less soundproof cars, especially when music is playing. Many accidents have resulted from this difficulty, as drivers are unable to hear sirens until it is too late to move out of the path of the emergency vehicle so that it can efficiently and quickly move through traffic and reach its destination. By flashing a warning light within the drivers' cars, the RF Siren System will allow drivers the advantage of being aware of the presence of an emergency vehicle at a distance where, in a normal situation, the driver would hardly be able to hear the siren. This advance notice will enable drivers to pull to the side of the road, clearing a path for the emergency vehicle. Not only will the RF Siren System reduce the number of accidents resulting from this type of situation, but it will also reduce the amount of time that it takes an emergency vehicle to reach its destination, potentially saving lives. The RF Siren System is advantageous to both emergency personnel and the general public.

### BACKGROUND OF THE INVENTION

The Radio Frequency Siren System, or RF Siren System, has been designed to visually notify vehicle drivers of the presence of emergency vehicles, such as fire engines and police cars. The RF Siren System consists of two parts, a RF siren signal generator that will be installed in the emergency vehicles and a RF siren receiver that will be installed in the cars of the general public. As cars are becoming increasingly more soundproof, it also becomes more difficult to hear incoming sirens early enough to make room for emergency vehicles. Oftentimes, drivers of cars, due to blasting music or closed windows, are unaware of the presence of emergency vehicles until the vehicle actually reaches the car. This situation inhibits the ability of the emergency vehicles to quickly maneuver through traffic and can result in serious accidents. To prevent this situation, the RF Siren System has been designed to visually notify drivers in the path of the emergency vehicle prior to the vehicle's arrival. When the emergency vehicle turns on its siren, the RF siren signal generator is also turned on, because it is connected to the siren switch. The RF siren receiver visually alerts vehicles in the path of the emergency vehicle by blinking the warning light within those vehicles. The RF siren receiver that is installed in the cars will be able to detect the radio signals from the RF siren signal generator of the emergency vehicles when they are within a couple of hundred yards. This will allow cars to make way for the emergency vehicles and will potentially save many lives and avoid any other consequent damages, which may result from a driver not hearing the siren.

### SUMMARY OF THE INVENTION

The primary objective of this invention is to provide a visual indication of emergency sirens that detects the presence of emergency vehicles through a flashing warning light, thereby allowing cars to pull to the side of the road and give the right of way to the incoming emergency vehicles.

### BRIEF DESCRIPTION OF THE DRAWING

This invention can be fully understood through references to the following figure and its brief description below:

FIG. 1 is a conceptual view of the RF Siren System, which is comprised of two parts, the RF siren generator and the RF siren receiver.

### DETAILED DESCRIPTION OF THE DRAWING

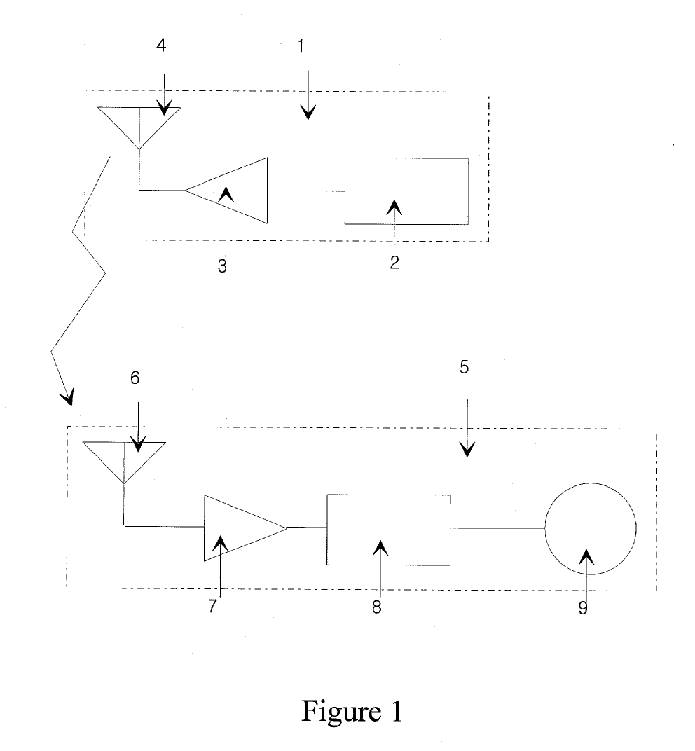

In FIG. 1, the RF siren generator 1 consists of an RF siren signal generator 2, an RF amplifier 3 and a transmission antenna 4. The RF siren receiver 5 consists of a receiving antenna 6, an RF amplifier 7, a demodulator 8 and a blinking warning light 9.

The RF siren receiver 5 will detect the radio signal from the RF siren signal generator 1 and turn on the blinking warning light 9, when the emergency vehicles have come within a couple hundred yards of the receiver.

I claimed:

1. An RF Siren System designed to give visual warning to drivers when emergency vehicles are approaching the car, allowing the drivers to pull off to the side of the road and permitting the emergency vehicles to pass.

2. Any RF siren generator of claimed 1.

3. Any RF siren receiver of claimed 1.

4. Any shape and size of the blinking warning light system of claimed 1.
